(19) United States
(12) Patent Application Publication
(10) Pub. No.: US 2026/0159743 A1
(43) Pub. Date: Jun. 11, 2026

(54) MICROCAPSULES CONTAINING BIO-BASED AGENTS FOR DOWNHOLE APPLICATIONS IN OIL AND GAS INDUSTRY AND METHOD OF THEIR PRODUCTION

(71) Applicant: SAUDI ARABIAN OIL COMPANY, Dhahran (SA)

(72) Inventors: Iaroslav Rybkin, Moscow (RU); Maxim Orlov, Moscow (RU); Abdulmohsen A. Humam, Dammam (SA)

(73) Assignee: SAUDI ARABIAN OIL COMPANY, Dhahran (SA)

(21) Appl. No.: 18/708,068

(22) PCT Filed: Jul. 10, 2023
(86) PCT No.: PCT/RU2023/000205

§ 371 Date: May 7, 2024

(51) Int. Cl. C09K 8/035; C09K 8/54

(52) U.S. Cl. CPC C09K 8/035; C09K 8/54; C09K 2208/24; C09K 2208/32

(57) ABSTRACT

A well treatment composition includes a bio-based agent, a polymer shell encapsulating the bio-based agent, and a cationic macromolecule deposited on the polymer shell. A method for producing microcapsules containing a bio-based agent includes forming a first aqueous phase which includes a bio-based agent and a polymerization mixture, mixing the first aqueous phase with an oil phase at a junction producing emulsions, polymerizing the polymerization mixture to form a polymer shell encapsulating the bio-based agent, depositing a cationic macromolecule onto the polymer shell utilizing a second aqueous phase to form a microcapsule, and optionally post-treating the microcapsules with a post-treatment. A method for treating a formation includes introducing a well treatment composition into a wellbore, the well treatment composition adhering to downhole surfaces, releasing a bio-based agent from the well treatment composition, and the bio-based agent performing an intended action downhole.

### BACKGROUND

Microbe use in downhole applications is advantageous due to microbes'ability to continually produce substances useful for downhole applications, which otherwise require periodic load. The production of substances useful for downhole applications by microbes is dependent on environmental conditions. Since downhole conditions are not typically suitable for microbes due to elevated temperatures, mechanical stress, or lack of nutrients, the direct introduction of microbes or enzymes is undesirable. Instead, there remains a need for preservation of microbes in downhole conditions.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a well treatment composition which includes a bio-based agent, a polymer shell encapsulating the bio-based agent, and a cationic macromolecule deposited on the polymer shell.

In another aspect, embodiments disclosed herein relate to a method for producing microcapsules containing a bio-based agent which includes forming a first aqueous phase which includes a bio-based agent, a first emulsion stabilizer, and a polymerization mixture, wherein the polymerization mixture includes a first monomer, a first prepolymer, a first polymer, or combinations thereof; mixing the first aqueous phase with an oil phase at a junction producing emulsions, wherein the oil phase optionally includes a second emulsion stabilizer, a second monomer, a second prepolymer, a second polymer, a catalyst, or mixtures thereof; polymerizing the polymerization mixture to form a polymer shell encapsulating the bio-based agent; depositing a cationic macromolecule onto the polymer shell utilizing a second aqueous phase to form a microcapsule; and optionally post-treating the microcapsules with a post-treatment.

In yet another aspect, embodiments disclosed herein relate to a method for treating a formation which includes introducing a well treatment composition into a wellbore; the well treatment composition adhering to downhole surfaces; releasing a bio-based agent from the well treatment composition; and the bio-based agent performing an intended action downhole.

Other aspects and advantages of the claimed subject matter will be apparent from the following description and the appended claims.

### BRIEF DESCRIPTION OF DRAWINGS

FIG. 1 is a block-flow diagram illustrating a method in accordance with one or more embodiments of the present disclosure.

FIG. 2 is an illustration of microcapsule formation in accordance with one or more embodiments of the present disclosure.

FIG. 3 is an illustration of cationic macromolecule deposition occurring after polymerization of the polymer shell in accordance with one or more embodiments of the present disclosure.

FIG. 4 is an illustration of cationic macromolecule incorporation into the microcapsule in accordance with one or more embodiments of the present disclosure.

FIG. 5 is a block-flow diagram illustrating a method in accordance with one or more embodiments of the present disclosure.

FIG. 6 is an illustration of microcapsule attachment to downhole surfaces in accordance with one or more embodiments of the present disclosure.

FIG. 7 is an illustration of bio-based agent release from microcapsules attached to downhole surfaces in accordance with one or more embodiments of the present disclosure.

### DETAILED DESCRIPTION

The present disclosure describes a well treatment composition containing a bio-based agent such as microbes or their metabolic products (i.e., enzymes, biosurfactants, antimicrobials etc.) used for downhole applications or other upstream operations, and the methods of its production and application downhole. The applications of the well treatment composition include but are not limited to, biofouling and biocorrosion prevention, biosurfactant production, cement healing, and degradation of various recalcitrant pollutants.

Further, the present disclosure describes a microbial microencapsulation technology which combines a microfluidic-based method with deposition of cationic macromolecues. Microfluidic-based systems provide high encapsulation accuracy as well as scalability. Additionally, microfluidic-based systems are widely used in biotechnological and biomedical applications to encapsulate various microbes or drugs. The surface of microcapsules may be modified with cationic macromolecules, which improve strength and the adhesion of the capsules to various surfaces. Both the scalability and ability to influence downhole surface adhesion are appealing features for downhole applications.

In one aspect, embodiments disclosed herein relate to a well treatment composition for use in downhole applications or other upstream operations. A well treatment composition may be used for several possible applications in a wellbore or other parts of a formation. A formation could be any subterranean formation related to petroleum extraction. In its finished state, the well treatment composition includes a bio-based agent, a polymer shell encapsulating the bio-based agent, and a cationic macromolecule deposited on the polymer shell. Optionally, the well treatment composition may include nutrients to aid in microbe growth and other additives.

In one or more embodiments, the polymer shell of the microcapsule is selected from the group consisting of a melamine-formaldehyde, a urea-formaldehyde, a phenol-formaldehyde resin, a melamine-phenol-formaldehyde resin, a furan-formaldehyde resin, an epoxy resin, a polysiloxane, a polyacrylate, a polyester, a polyurethane, a polyamide, a polyether, a polyimide, a polyolefin, polypropylene-polyethylene copolymers, polystyrene, functionalized polystyrene derivatives, gelatin, a gelatin derivative, cellulose, a cellulose derivative, starch or a starch derivative, a polyvinyl alcohol, an ethylene-vinylacetate copolymer, a maleic-anhydride based copolymer, a polyacrylamide, a polyacrylamide based copolymer, a polyacrylic acid, a polyacrylic acid based copolymer, a polyvinylpyrrolidone, a polyvinylpyrrolidone based copolymer, a polyacrylate based copolymer, propylene-acrylate copolymer, propylene-methacrylate copolymers, oxidized polypropylene, oxidized polyethylene, propylene-ethylene oxide copolymers, styrene-acrylate copolymers and acrylonitrile-butadiene-styrene copolymers, a Pickering stabilizer, silica gel, silica gel derivative, alginate, alginate derivative, agarose, agar, xantham gum, locust bean gum, gellan gum, carrageenan gum, derivatives and mixtures thereof. It will be understood by one with skill in the art that because the polymer shell may be formed from a mixture of multiple monomers, prepolymer, and polymers, the polymer shell may be a complex mixture of crosslinked copolymers, or similar structures.

In one or more embodiments, the cationic macromolecule deposited on the polymer shell is selected from the group consisting of primary amines, secondary amines, tertiary amines, quaternary amines, amino acids, proteins, polysaccharide containing amino groups, amino sugars, their derivatives, and mixtures. The cationic macromolecule may be natural or synthetic. The position of the cationic macromolecule is dependent on the cationic macromolecule's order of addition in production of the microcapsules. Although the cationic macromolecules can be deposited on the surface of the polymer shell, the cationic macromolecules may also be incorporated into the interior of the microcapsules or as part of the polymer shell. The preferred positioning of the cationic macromolecule would be on the outside of the polymer shell due to the cytotoxic effect of cationic species on microbes.

In one or more embodiments, the bio-based agent is selected from the group consisting of microbes, the metabolic products of microbes, their derivatives, and combinations thereof. Microbes may include bacteria, fungi, archaea, or combinations thereof. The metabolic products of microbes may include any compounds produced by microbes which can be used for downhole applications. The metabolic products of microbes include, but are not limited to, biosurfactants, antibiotics, antimicrobials, descaling agents, enzymes such as carbonic anhydrase and urease, their derivatives, or combinations thereof.

In one or more embodiments, the well treatment composition may include nutrients to aid microbe growth selected from the group consisting of proteins, glycoproteins, hydrolyzed proteins, peptides, polysaccharides, oligosaccharide, disaccharides, monosaccharides, fatty acids, ethers of fatty acids, their derivatives, and mixtures thereof. The well treatment composition may also include additives selected from the group consisting of enzymes, vitamins, growth factor, antibiotics, buffer salts, divalent salts, nitrogen salts, heat resistant proteins and enzyme stabilizers, their derivatives, and mixtures thereof.

In another aspect, embodiments disclosed herein relate to a system for producing a well treatment composition. The system for producing a well treatment composition includes a first aqueous phase, an oil phase, a second aqueous phase, and a microfluidic device, wherein the microfluidic device is used to form the well treatment composition.

In one or more embodiments, the first aqueous phase includes a bio-based agent, a first emulsion stabilizer, and a polymerization mixture. The first aqueous phase may optionally include a first catalyst. The oil phase may optionally comprise a second emulsion stabilizer, a second monomer, a second prepolymer, a second polymer, a second catalyst, or mixtures thereof. The second aqueous phase includes a cationic macromolecule. The polymerization mixture includes a first monomer, a first prepolymer, a first polymer, or combinations thereof.

In one or more embodiments, the first emulsion stabilizer and second emulsion stabilizer are surfactants selected from the group consisting of fatty acids, amino alcohols, fatty alcohols, fatty mercaptans, polyethylene glycol, polypropylene glycol, polyvinyl alcohol, polysorbates, fatty acid esters of sorbitol, fatty acid esters of glycerol, fatty acid esters of polyhydroxy compounds, alkylphenol ethoxylates, alkyl polyglucosides, fatty alcohol ethoxylates, ethoxylated amines and/or fatty acid amides, cetrimonium bromide, octenidine dihydrochloride, dioctadecyldimethylammonium bromide, cetylpyridinium chloride, benzalkonium chloride, benzethonium chloride, dimethyldioctadecylammonium chloride, ammonium lauryl sulfate, sodium lauryl sulfate, ammonium dodecyl sulfate, sodium dodecyl sulfate, sodium lauryl ether sulfate, sodium myreth sulfate, dioctyl sodium sulfosuccinate, perfluorobutanesulfonate, alkyl-aryl ether phosphates, alkyl ether phosphates, alkyl aryl sulfonates, alkyle benzene sulfonates, alkyl sulfates, N-ethoxy sulfonates, sodium dodecyl sulfates, alcohol propoxy sulfates, alkyl ethoxy sulfates, alpha-olefin sulfonates, alpha-olefin sulfates, branched alkyl benzene sulfonates, docusate sodium, ethoxy glycidyl sulfonates, propoxy glycidyl sulfonates, alkyl ether sulfates, internal olefin sulfonates, sulfonated ethoxylated alcohols, sulfonated ethoxylated alkyl phenols, sodium petroleum sulfonates, alkyl alcohol propoxylated sulfates, alkyl phenols, monoglycerides, diglycerides, guar gum, canola oil, lecithin, carrageenan, ammonium phosphatide, derivatives and mixtures thereof.

In one or more embodiments, the microfluidic device is a microfluidic chip. Utilizing a microfluidic chip provides several advantages detailed above. In one or more embodiments, the first aqueous phase and the oil phase form an emulsion at a junction in the microfluidic device. In one or more embodiments, the polymerization mixture is polymerized, forming a polymer shell encapsulating the bio-based agent. The second aqueous phase may be utilized to deposit the cationic macromolecule onto the surface of the polymer shell, forming a microcapsule. The cationic macromolecule may be added before during or after polymerization of the polymer shell. In one or more embodiments, the first aqueous phase optionally includes nutrients for cell growth selected from the group consisting of proteins, glycoproteins, hydrolyzed proteins, peptides, polysaccharides, oligosaccharide, disaccharides, monosaccharides, fatty acids, ethers of fatty acids, their derivatives, and mixtures thereof. In one or more embodiments, the first aqueous phase optionally includes additives selected from the group consisting of enzymes, vitamins, growth factors, antibiotics, buffer salts, divalent salts, nitrogen salts, heat resistant proteins, enzyme stabilizers, their derivatives, and mixtures thereof.

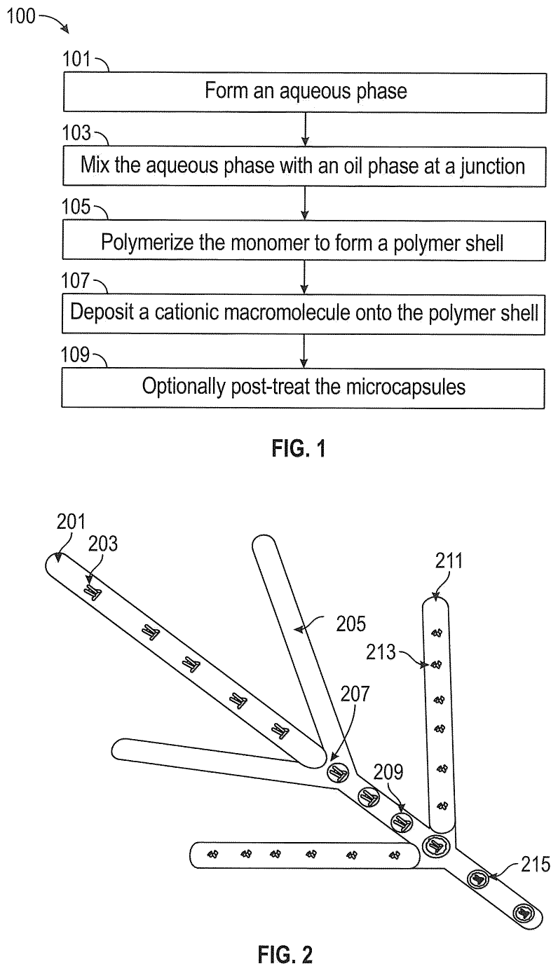

In another aspect, embodiments disclosed herein relate to a method 100 for production of the well treatment composition, as shown in FIG. 1. The method includes forming a first aqueous phase including a bio-based agent, a first emulsion stabilizer, and a polymerization mixture, at block 101. The polymerization mixture may include a first catalyst, a first monomer, a first prepolymer, a first polymer, or combinations thereof. The first aqueous phase is mixed with an oil phase at a junction producing emulsions at block 103. The oil phase optionally includes a second emulsion stabilizer, a second monomer, a second prepolymer, a second polymer, a second catalyst, or mixtures thereof. The polymerization mixture is polymerized to form a polymer shell, at block 105. A second aqueous phase is utilized to deposit a cationic macromolecule onto the polymer shell to form a microcapsule, at block 107. The microcapsules may be optionally post treated with a post-treatment, at block 109. FIGS. 2-4 illustrate additional aspects of microcapsule production.

Forming the first aqueous phase includes dissolving or dispersing the components to produce microcapsules in an aqueous mixture. These dissolved or dispersed components may include a first emulsion stabilizer, a first catalyst, a bio-based agent, and a polymerization mixture. The polymerization mixture may include a first monomer, first prepolymer, and first polymer, in combination or individually. The dissolved or dispersed components in the first aqueous phase may also include nutrients for microbe growth and additives. The first aqueous phase may be made up of several different aqueous mixtures that are kept separate until production and may be introduced into the process of microcapsule production separately. The separate introductions are performed to avoid reactivity or stability issues before the desired reaction in microcapsule production. One of ordinary skill in the art will understand that many separate aqueous mixtures may be prepared and introduced into the process of microcapsule production separately and in different orders to contribute to the function of the first aqueous phase. Typically, any separately prepared aqueous phases are combined as part of the formation of the first aqueous phase before being combined with the oil phase.

In one or more embodiments, after formation of the first aqueous phase the first aqueous phase is mixed with an oil phase at a junction, producing an emulsion, which contains the content of the aqueous and oil phases. A junction in a microfluidic device is where two channels meet and have their respective fluids mixed, in this case producing emulsions. As understood by one skilled in the art, an emulsion is a fine dispersion of one liquid in another in which it is not soluble or miscible. The produced emulsion may include a sub-micron emulsion, a microemulsion, a mini-emulsion, emulsions, and suspensions. The oil phase may include a second emulsion stabilizer, a second monomer, a second prepolymer, a second polymer, a second catalyst, or mixtures thereof. The second emulsion stabilizer, second monomer, second prepolymer, and second polymer may be the same or different as used in forming the first aqueous phase. The oil used in the oil phase may be selected from the group consisting of mineral oil, silicon oil, fluorinated oil, and vegetable oil. Other oils may be used, which are suitably compatible with a bio-based agent of interest. One or more of each phase may have a corresponding catalyst. When each phase has a catalyst, the catalysts for each phase may be the same or differ.

The choice of each catalyst depends on the particular chemical reaction selection for the polymerization process. For example, for melamine-formaldehyde resins the catalysts can include sulfonic acids (p-toluenesulfonic acid), sodium hydroxide, ammonia. For phenol-formaldehyde resins the catalysts can include sulfuric acid, hydrochloric acid, sodium hydroxide, potassium hydroxide. For urea-formaldehyde resins the catalysts can include ammonium chloride, ammonium sulfate. For epoxy resins the catalysts can include sulfonic acids (p-toluenesulfonic acid), dicyandiamide, triethylenetetramine. For polyurethane/urea resins the catalysts can include amines including triethylenediamine and N,N-dimethylcyclohexylamine, or organometallic catalysts including organotin, bismuth and zinc catalysts. For polyester resins the catalysts can include methyl ethyl ketone peroxide.

Initiators used in chain-growth polymerization reaction may vary by the type of reaction. For example, for acrylamide reactions initiators can include ammonium persulfate. For acrylic acid reactions initiators can include potassium persulfate. For acrylic ester reactions initiators can include organic peroxides (benzoyl peroxide, cumene hydroperoxide). For methacrylic acid reactions initiators can include tert-butyl peroxypivalate. For methacrylic ester reactions initiators can include peroxodisulfate. For styrene reactions initiators can include organic peroxides such as benzoyl peroxide. For 4-vinylbenzyl chloride reactions initiators can include organic peroxides such as benzoyl peroxide. For divinylbenzene reactions initiators can include azo compounds (azobisisobutyronitrile). For methylenebisacrylamide reactions initiators can include azo compounds (azobisisobutyronitrile), cerium sulphate.

An emulsion can be a discontinuous internal water phase in a continuous oil phase, forming water-in-oil emulsions (W/O), or can be a number of other possibilities including oil-in-water (O/W) emulsions. Also, the emulsion may be more complicated with the discontinuous phase itself being a dispersion, such as a water-in-oil-in-water (W/O/W) or oil-in-water-in-oil (O/W/O) type of emulsion.

After the formation of an emulsion, the polymerization mixture which resides as a component of the emulsion is polymerized to form a polymer shell. Polymerization of the polymerization mixture may involve the polymerization of monomers to form polymers, the reaction of prepolymers to form larger molecules or crosslinked structures, the crosslinking of polymers, or combinations of any of these processes, depending on the composition of the polymerization mixture. The polymerization of the polymerization mixture may occur in the first aqueous phase, the oil phase, or the interphase between aqueous and oil phases, more than one of these phases or in all these phases. The polymerization of the polymerization mixture may be termed emulsion polymerization, mini-emulsion polymerization, sub-micron emulsion polymerization, microemulsion polymerization, suspension polymerization, colloid polymerization, interfacial polymerization, or thermal gelation. The polymerization of the polymerization mixture may be thermal gelation of dissolved polymer, resulting in the formation of solidified microcapsules when temperature drops. The polymerization of the polymerization mixture may be chain-growth polymerization of monomers or condensation polymerization of corresponding monomers and prepolymers.

The polymerization of the polymerization mixture may be a result of cross-linking of a polymer with initiators such as salts. Initiators or catalysts may be used to aid in the polymerization of the polymerization mixture. Chain-growth monomers may include acrylamide, acrylic acid, acrylic esters, methacrylic acid, methacrylic esters, styrene, 4-vinylbenzyl chloride, divinylbenzene, and methylenebisacrylamide. Condensation prepolymers or polymers may include melamine-formaldehyde resins, phenol-formaldehyde resins, urea-formaldehyde resins, epoxy resins, urethane/urea resins, and polyester resins. Thus, once polymerized, the polymerization mixture forms a polymer shell that includes the reaction products of monomers, prepolymers, polymers, or combinations thereof.

To impart a positive surface charge, cationic macromolecules may be deposited on the surface of the microcapsule or otherwise incorporated into the polymer shell. Ensuring cationic macromolecules are part of the microcapsule can occur in several ways, including dispersing cationic macromolecules in the first aqueous phase during initial mixing of the components. Ensuring cationic macromolecules are on the surface of the microcapsule can also be achieved if the microcapsule polymer shell is composed of cationic macromolecules or the polymer shell has been additionally modified with amine groups. In one or more embodiments, the cationic macromolecule is dissolved or dispersed in a second aqueous phase which is added to the process of microcapsule formation after polymerization of microcapsules, enabling deposition of the cationic macromolecule on the surface of the polymer shell. Solely depositing the cationic macromolecules on the surface of the polymer shells will avoid unwanted contact with any cells encapsulated by the polymer shell. Once the cationic macromolecule has been deposited on the surface of the polymer shell or otherwise incorporated by polymerization of the polymerization mixture, a microcapsule with a positive surface charge is formed.

In one or more embodiments, the method includes further post-treatment of the microcapsules. Post-treatment may include the growth of microbes in the microcapsules to increase the concentration of desired substances. The microcapsules may be air dried, spray dried, freeze dried, bed dried or left without any treatment. The microcapsules may also be added to other formulations for use in downhole applications.

In one or more embodiments, a microfluidic chip is utilized to produce the well treatment composition. Utilizing a microfluidic chip provides several advantages, including a high level of control over processing. For instance, the components to produce microcapsules may be fed through a temperature-controlled set of syringe pumps that allow for constant feeding into the microfluidic chip. In addition, each syringe pump may use a feed rate control unit for precise dosing. Furthermore, using a microfluidic chip allows for addition of multiple phases in variable orders. The ability to prepare and accurately dose multiple phases including multiple aqueous phases into a microfluidic chip allows for incompatible compounds to remain isolated before use. The ability to prepare and accurately dose multiple phases also allows for addition of specific components at desired points in the process, such as depositing the cationic macromolecules on the surface of the polymer shells utilizing a second aqueous phase. When microcapsule production is performed using a microfluidic chip, the polymerization of the polymerization mixture to form the polymer shell may occur inside or outside the microfluidic chip.

FIG. 2 depicts the formation of microcapsules in a microfluidic device. A first aqueous phase 201 containing dispersed components for microcapsule formation 203 is mixed with an oil phase 205 at junction 207. The components of the first aqueous phase and components of the oil phase are as described above.

When the first aqueous phase 201 and oil phase 205 are mixed at the junction 207, emulsions 209 are formed, here depicted as water-in-oil emulsions. Although a simple water-in-oil emulsion is depicted in FIG. 2, the emulsion may be more complicated with the discontinuous phase itself being an emulsion, such as a water-in-oil-in-water or oil-in-water-in-oil type of emulsion. Once the emulsions form, they may be polymerized into a polymer shell. A polymer shell may be formed when the emulsions that contain the polymerization mixture polymerize or crosslink into a shell. The formation of the polymer shell encapsulates the bio-based agent and other components of the first aqueous phase 201, such as any nutrients or additives. Next, a second aqueous phase 211 is conveyed to the composition, delivering a cationic macromolecule 213 that deposits onto the polymer shell to form a microcapsule. Although the cationic macromolecule addition could be performed before, during, or after polymerization of the polymerization mixture to form a polymer shell, FIG. 2 depicts cationic macromolecule addition after polymer shell formation.

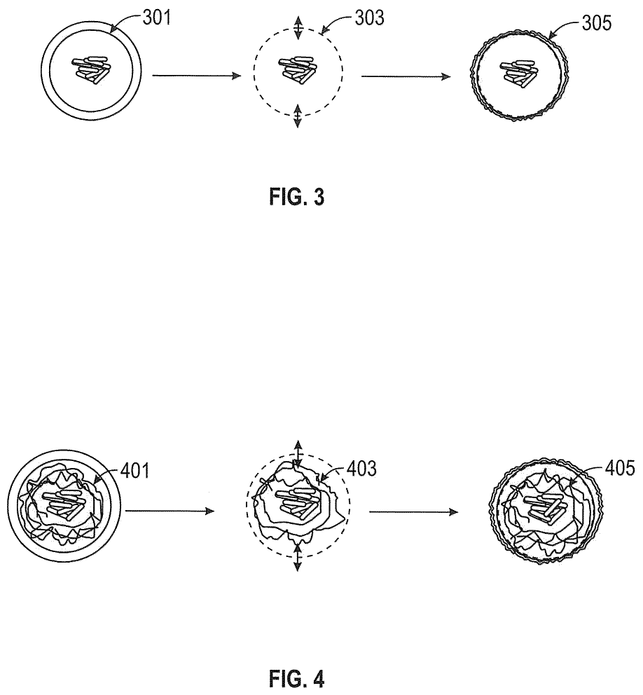

FIGS. 3 and 4 depict cationic macromolecule addition at different stages of microcapsule formation. FIG. 3 shows deposition of cationic polymers on the surface of polymerized microcapsules. The emulsions 301 have been formed in a junction and contain polymerization mixture that is undergoing polymerization. After the polymer shell has been formed through polymerization of the polymerization mixture the structure 303 is formed which encapsulates the bio-based agent and provides a solid surface for cationic macromolecule deposition. After cationic macromolecule deposition, a finished microcapsule 305 is formed. The cationic macromolecules may also be included in the first aqueous phase with the polymerization mixture and other components. FIG. 4 shows when polymerization of an emulsion containing dissolved cationic polymer forms a positively charged microcapsule. In this case, the cationic macromolecule has been included in the first aqueous phase and the dissolved components including cationic polymer form W/O emulsions 401 The polymerization mixture contained in the emulsions undergoes polymerization to encapsulate the contents that includes cationic macromolecule in addition to the bio-based agent, shown as 403. This leads to a finished microcapsule 405 that has cationic macromolecules distributed on the surface and inside the microcapsule.

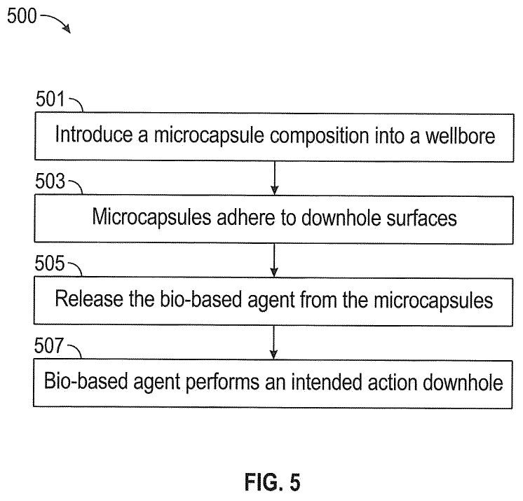

In another aspect, embodiments disclosed herein relate to a method 500 of microcapsule application in a downhole environment, which is summarized in FIG. 5. First, a well treatment composition is introduced into a wellbore, at block 501. Then, the microcapsules adhere to downhole surfaces due to electrostatic interactions, at block 503. Next, the bio-based agent is released from the microcapsules, at block 505. Then, the bio-based agent performs an intended action downhole, at block 507.

In one or more embodiments, the prepared microcapsules are introduced into a wellbore and are transported to a desired area downhole. Any typical methods for transport downhole, such as drilling mud flow, can be used to deliver the well treatment composition to the target area. The well treatment composition may also be added to other mixtures before delivery downhole.

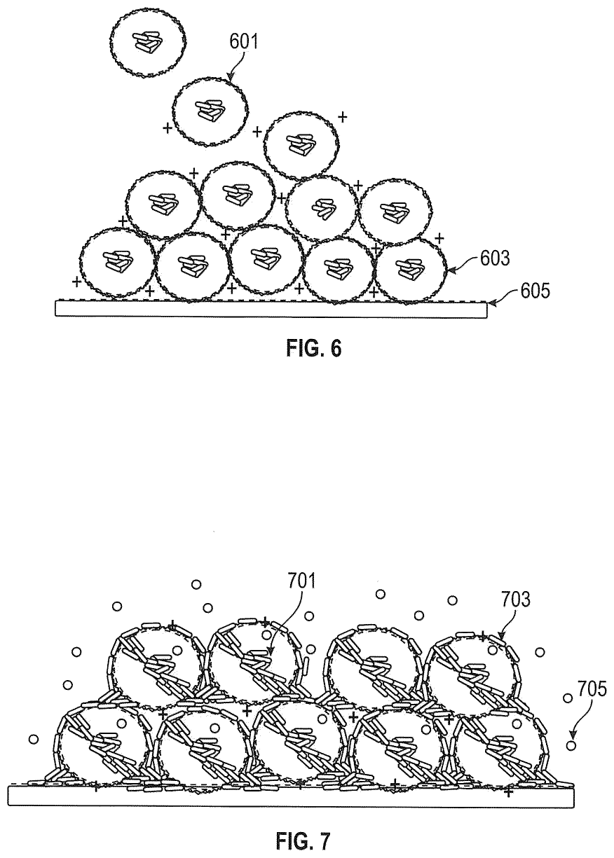

FIG. 6 illustrates how the microcapsules adhere to downhole surfaces. Once the microcapsules 601 are introduced in a downhole environment, the cationic macromolecules deposited on the microcapsule surface 603 enable a robust electrostatic attachment of the microcapsules to the negatively charged downhole surface 605. The microcapsules have been designed with a positively charged surface, imparted by the cationic macromolecules, because the downhole surfaces are negatively charged. If the microcapsules were not positively charged, they would lack sufficient electrostatic attraction to the downhole surfaces and thus would not adhere and would fail in application.

In one or more embodiments, the encapsulated bio-based agent is released from the microcapsules through diffusion out of microcapsule pores, rupture caused by mechanical friction, or rupture caused by growth of microbes inside the microcapsules. The size of the microcapsule pores may be optimized to facilitate the diffusion of the bio-based agent from the microcapsule. The materials used for encapsulation along with process parameters during formation will affect the properties of microcapsule pores. Some parameters that may affect pore size include polymer concentration, polymer molecular weight, crosslinking method, crosslinking time, crosslinking temperature, and crosslinking pH. With respect to polymer concentration, higher polymer concentrations tend to result in smaller pores or a denser network structure, while lower concentrations can lead to larger pores or a more porous structure. With respect to cross-linking method, for example, in the case of alginate, crosslinking with divalent cations like calcium ions can create larger pores compared to crosslinking with trivalent cations like aluminum ions. With respect to crosslinking time, the duration of crosslinking can influence pore size and density. Longer crosslinking times often result in smaller and more closely spaced pores. With respect to polymer molecular weight, higher molecular weight polymers tend to form smaller pores due to increased polymer entanglement and a tighter network structure. With respect to gelation temperature, lower gelation temperatures may lead to larger and more interconnected pores, while higher temperatures can result in smaller and more isolated pores. With respect to gelation pH, altering the pH can change the gelation kinetics and affect the size and structure of the pores in the microcapsules.

FIG. 7 illustrates how the bio-based agents may be released from microcapsules 701 attached to a downhole surface. Successful adhesion to the downhole surface and proper design of the microcapsule including nutrients for microbe growth will result in the growth of microbes inside the microcapsules adhered to downhole surfaces. Continued growth of the microbes inside the microcapsules will lead to increased levels of microbes 703 and microbe metabolic products 705 being released from the adhered microcapsules. Eventually the growth of microbes will lead to rupture of the microcapsules. Microcapsule rupture could also occur through mechanical friction or other physical means. One with skill in the art will understand that the bio-based agents such as microbes and microbe metabolic products will likely be released through a number of different mechanisms including diffusion before eventual rupture. Once the bio-based agent is released, it performs an intended action in downhole conditions.

### Examples of Potential Microbial Systems for Downhole Applications

### Example 1. Biofouling Mitigation and Biocorrosion Prevention

Microcapsules encapsulating cells of Bacillus pumilus DEV1 or Bacillus brevis DSM 30 will be used to mitigate biofouling and prevent corrosion in downhole operations. B. pumilus DEV1 will mitigate biofouling by releasing antimicrobial substances which have been proven to work against such strains as Bacillus subtilis, Micrococcus luteus, Escherichia coli, and Desulfovibrio vulgaris. B. brevis DSM 30 will mitigate biocorrosion by producing antibiotic gramicidin C, an antibiotic known to be active against Gram-positive bacteria.

### Example 2. Degradation of Recalcitrant Pollutants

Microcapsules encapsulating cells of Rhizomucor miehei and Bacillus cereus EN18 will be utilized for biodegradation of recalcitrant pollutants of slop oil. The cells of Rhizomucor miehei produce lipase enzymes, while the cells of Bacillus cereus EN18 are able to grow on hydrocarbon substrates utilizing the R. miehei produced lipase, as described in Marchut-Mikolajczyk, O., Drożdżyński, P., & Struszczyk-Świta, K. (2020). Biodegradation of slop oil by endophytic Bacillus cereus EN18 coupled with lipase from Rhizomucor miehei (Palatase®). Chemosphere, 250, 126203. As a result, such a combination will significantly improve the bioremediation process.

### Example 3. Biosurfactant Production

Microcapsules encapsulating cells of Bacillus subtilis B30 will be applied for oil recovery enhancement. Recovery enhancement is achieved by B. subtilis B30 cells producing biosurfactants. The biosurfactant produced by B. subtilis B30 has been shown to be stable under various pH and temperature conditions and will improve oil recovery of light and heavy oils (Al-Wahaibi, Y., Biosurfactant production by Bacillus subtilis B30 and its application in enhancing oil recovery, Colloids and Surfaces B: Biointerfaces, Volume 114, 2014, pages 324-333). In this particular example, the selected microbe produces one type of biosurfactant. However, in general there can be more than one produced biosurfactants. It depends on the choice of microorganisms and media (i.e. encapsulated nutrients, crude oil or specific fraction of oil). The composition of media in this case may define what kind of surfactant is produced.

### Example 4. Cement Healing

Microcapsules encapsulating cells of Sporosarcina pasteurii will be used for addition into self-healing cements. The cells of S. pasteurii have been shown to decompose urea, which in return stimulates calcium carbonate precipitation. Eventually, precipitated calcium carbonate may fill cracks in the cement.

### Example 5. Production of Descaling Agents

Microcapsules encapsulating cells of Lactobacillus species such as Lactobacillus acidophilus, Lactobacillus brevis, Lactobacillus casei, Lactobacillus delbrueckii, Lactobacillus fermentum, Lactobacillus gasseri, Lactobacillus helveticus, Lactobacillus iners, Lactobacillus jensenii, Lactobacillus lactis, Lactobacillus plantarum, Lactobacillus reuteri, Lactobacillus salivarius, and Lactobacillus sakei will be applied for descaling. The cells of Lactobacillus species will produce lactic acid, which is a known ecofriendly descaling agent which can be applied downhole for reservoir treatment.

Embodiments of the present disclosure may provide at least one of the following advantages. Utilizing a microfluidic means of microcapsule production such as a microfluidic chip may impart high encapsulation accuracy as well as scalability, may improve the size distribution of produced microparticles, and may enable high efficiency of bio-based agent loading. Encapsulating microbes in a polymer shell may protect the microbes so that they can be utilized downhole, as opposed to the harsh downhole environment destroying the microbes before their intended function. The cationic macromolecules deposited on the surface of the microcapsules may enable microcapsule attachment to negatively charged downhole surfaces, where otherwise microcapsules lacking cationic surface charge would not adhere to downhole surfaces and thus would not be able to be delivered to target areas downhole. When the microcapsules release their encapsulated bio-based agents in the target area downhole, the bio-based agents may perform a number of desired functions downhole. The continued growth of the microbes in the microcapsules may lead to steady release of the bio-based agent, where inefficient periodic loading of bio-based agents may have been previously required.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A well treatment composition, the well treatment composition comprising:
a bio-based agent, a polymer shell encapsulating the bio-based agent, and a cationic macromolecule deposited on the polymer shell.

2. The well treatment composition of claim 1, wherein the polymer shell is selected from the group consisting of step-growth polymers, chain-growth polymers, and crosslinked resins.

3. The well treatment composition of claim 1, wherein the cationic macromolecule deposited on the polymer shell is selected from the group consisting of amines, proteins, polysaccharides containing amino groups, amino sugars, derivatives, and mixtures thereof.

4. The well treatment composition of claim 1, wherein the bio-based agent comprises bacteria, fungi, archaea, biosurfactants, antibiotics, antimicrobials, descaling agents, enzymes, or combinations thereof.

5. The well treatment composition of claim 1, wherein the well treatment composition optionally comprises nutrients for cell growth selected from the group consisting of proteins, glycoproteins, hydrolyzed proteins, peptides, polysaccharides, oligosaccharide, disaccharides, monosaccharides, fatty acids, ethers of fatty acids, their derivatives, and mixtures thereof.

6. The well treatment composition of claim 1, wherein the well treatment composition optionally comprises additives selected from the group consisting of enzymes, vitamins, growth factors, antibiotics, buffer salts, divalent salts, nitrogen salts, heat resistant proteins, enzyme stabilizers, their derivatives, and mixtures thereof.

7. A method for producing microcapsules containing a bio-based agent, the method comprising:
forming a first aqueous phase comprising a bio-based agent, a first emulsion stabilizer, and a polymerization mixture, wherein the polymerization mixture comprises a first monomer, a first prepolymer, a first polymer, or combinations thereof;
mixing the first aqueous phase with an oil phase at a junction producing emulsions, wherein the oil phase optionally comprises a second emulsion stabilizer, a second monomer, a second prepolymer, a second polymer, a catalyst, or mixtures thereof;
polymerizing the polymerization mixture to form a polymer shell encapsulating the bio-based agent;
depositing a cationic macromolecule onto the polymer shell utilizing a second aqueous phase to form a microcapsule; and
optionally post-treating the microcapsules with a post-treatment.

8. The method of claim 7, wherein the first emulsion stabilizer and second emulsion stabilizers are surfactants.

9. The method of claim 7, wherein the polymer shell is selected from the group consisting of step-growth polymers, chain-growth polymers, and crosslinked resins.

10. The method of claim 7, wherein the bio-based agent comprises microbes, microbe metabolic products, or combinations thereof.

11. The method of claim 7, wherein the cationic macromolecule deposited on the polymer shell is selected from the group consisting of amino acids, proteins, polysaccharides containing amino groups, amino sugars, derivatives, and mixtures thereof.

12. The method of claim 7, wherein the first aqueous phase optionally comprises nutrients for cell growth selected from the group consisting of proteins, glycoproteins, hydrolyzed proteins, peptides, polysaccharides, oligosaccharide, disaccharides, monosaccharides, fatty acids, ethers of fatty acids, their derivatives, and mixtures thereof.

13. The method of claim 7, wherein the first aqueous phase optionally comprises additives selected from the group consisting of enzymes, vitamins, growth factors, antibiotics, buffer salts, divalent salts, nitrogen salts, heat resistant proteins, enzyme stabilizers, their derivatives, and mixtures thereof.

14. The method of claim 7, wherein the cationic macromolecule is added before, during or after polymerization of the polymer shell.

15. A method for treating a formation, the method comprising:
introducing a well treatment composition into a wellbore;
well treatment composition adhering to downhole surfaces;
releasing a bio-based agent from the well treatment composition; and
bio-based agent performing an intended action downhole.

16. The method of claim 15, wherein the well treatment composition comprises a bio-based agent, a polymer shell encapsulating the bio-based agent, and a cationic macromolecule deposited on the polymer shell.

17. The method of claim 15, wherein the well treatment composition adhering to downhole surfaces is due to electrostatic interactions between the microcapsules and downhole surfaces.

18. The method of claim 15, wherein the intended action of the bio-based agent could include but is not limited to biofouling mitigation, biocorrosion prevention, degradation of recalcitrant pollutants, biosurfactant production, cement healing, and production of descaling agents.

19. The method of claim 15, wherein the bio-based agent release from the microcapsules occurs through diffusion, microcapsule degradation caused by mechanical friction, or microcapsule rupture caused by cell growth inside the microcapsules.

20. The method of claim 15, wherein the bio-based agent is selected from the group consisting of Bacillus pumilus DEV1, Bacillus brevis DSM 30, Rhizomucor miehei, Bacillus cereus EN18, Bacillus subtilis B30, Sporosarcina pasteurii, Lactobacillus, and combinations thereof.
